(19) United States
(12) Patent Application Publication
(10) Pub. No.: US 2026/0052327 A1
(43) Pub. Date: Feb. 19, 2026

(54) UNIVERSAL MESH

(71) Applicant: Panduit Corp., Tinley Park, IL (US)

(72) Inventors: Jose M. Castro, Naperville, IL (US); Richard J. Pimpinella, Prairieville, LA (US)

(73) Assignee: Panduit Corp., Tinley Park, IL (US)

(21) Appl. No.: 19/181,694

(22) Filed: Apr. 17, 2025

Related U.S. Application Data
(60) Provisional application No. 63/644,069, filed on May 8, 2024.

(51) Int. Cl. H04Q 11/00

(52) U.S. Cl. CPC H04Q 11/0005; H04Q 2011/0056

(57) ABSTRACT

An optical interconnection assembly has Spine multi-fiber optical connectors and Leaf multi-fiber optical connectors. The Spine optical connectors of the interconnection assembly are optically connected to multi-fiber connectors of Spine switches via Spine patch cords. The Leaf multi-fiber connectors are optically connected to Leaf multi-fiber connectors of Leaf switches via Leaf patch cords. A plurality of fiber optic cables in said interconnection assembly serves to optically connect every Spine multi-fiber connector to every Leaf multi-fiber connector so that every Spine switch is optically connected to every Leaf switch. The optical interconnection assembly facilitates the deployment of network Spine-and-Leaf interconnections and the ability to scale out the network by using simplified methods described in this disclosure.

### CROSS REFERENCE TO RELATED APPLICATION(S)

This application claims benefit to U.S. Provisional Patent Application No. 63/644,069, filed May 8, 2024, the entirety of which is hereby incorporated by reference herein.

### FIELD OF INVENTION

The present disclosure relates to folded Clos optical networks and in particular, an optical interconnection assembly and scale-out method for spine-and-leaf switching networks, providing Spine-and-Leaf network cabling employing optical interconnection assemblies.

### BACKGROUND AND PRIOR ART EVALUATION

The use of optical fiber for transmitting communication signals has been rapidly growing in importance due to its high bandwidth, low attenuation, and other distinct advantages, including radiation immunity, small size, and lightweight. Datacenter architectures using optical fiber are evolving to meet global traffic demands and the increasing number of users and applications. The rise of cloud data centers, particularly the hyperscale cloud, has significantly changed the enterprise information technology (IT) business structure, network systems, and topologies. Moreover, cloud data center requirements are impacting technology roadmaps and standardization.

The wide adoption of server virtualization and advancements in data processing and storage technologies have produced the growth of East-West traffic within the data center. Traditional three-tier switch architectures comprising Core, Aggregation, and Access (CAA) layers cannot provide the low and equalized latency channels required for East-West traffic. Moreover, since the CAA architecture utilizes spanning tree protocol to disable redundant paths and build a loop-free topology, it underutilizes the network capacity.

The Folded Clos network (FCN) or Spine-and-Leaf architecture is a better-suited topology to overcome the limitation of the three-tier CAA networks. A Clos network is a multilevel circuit switching network introduced by Charles Clos in 1953. Initially, this network was devised to increase the capacity of crossbar switches. It became less relevant due to the development and adoption of Very Large Scale Integration (VLSI) techniques.

The use of complex optical interconnect topologies initially for high-performance computing (HPC) and later for cloud data centers makes FCN mostly known as Spine-and-Leaf architecture this architecture relevant again. Note that in the original work, the terms Spine and Leaf are not used, instead, the middle stage crossbar switches represent what is named Spine switches, and the ingress/egress stage crossbar switches what is named the Leaf switches. Those terms, Spine, and Leaf will be used in this document.

The Folded-Clos network topology utilizes two types of switch nodes, Spine, and Leaf. Each Spine is connected to each Leaf. The network can scale horizontally to enable communication between a large number of servers while minimizing latency and non-uniformity by simply adding more Spine and Leaf switches.

This architecture has been proven to deliver high-bandwidth and low latency (a maximum of only two hops to reach the destination), providing low oversubscription connectivity. However, for large numbers of switches, the Spine-Leaf architecture requires a complex mesh with large numbers of fibers and connectors, which increases the cost and complexity of the installation.

To understand the complexity, we define Ml as the number of ports used by the Leaf switches and Nl as the number of Leaf switches, Ms as the number of ports used by the Spine switches, and Ns as the number of Spine switches. Following the original definition of FCN [See Reference 1] and subsequent technical literature such as [See Reference 2], since all Spines transmit to all Leaf switches, Ns×Ms channels or lanes transmit data from Spine to Leaf, where x is the multiplication operator. For high-speed data communications, an optical communication channel is often comprised of multiple lanes, where the sum of individual lanes constitutes the aggregate data rate. Since all Leaf switches transmit to all Spine switches, it follows that Nl×Ml lanes transmit data from the Leaf switches. In FCN the allocated lanes from Leaf to Spines is similar to Spine to Leaf, therefore Ns×Ms=Nl×Ml. To compute the total number of lanes required to connect the fabric is given by Nlanes=Ns×Ms+Nl×Ml=2×Ns×Ms=2×Nl×Ml. Typically the number the fibers required is similar to the Nlanes. However, using bidirectional transceivers, where transmitting a receiving signal travel in the same fiber, the number of optical fiber can be reduced to Nlanes/2.

FIG. 1 shows an example of an FCN that connects Ns=32 Spine switches, 100 to Nl=32 Leaf switches, 200, using fabric 300. Each line in the fabric, e.g., 305 represents one duplex channel. Note that the figure focuses on the fabric topology and does not indicate the actual physical location of the Spine and Leaf switches. Based on industry telecommunications infrastructure Standard TIA-942-A, the locations of Leaf and Spine switches can be separated by tens or hundreds of meters. Typically, Spine switches are located in the main distribution area (MDA), whereas Leaf switches are located in the equipment distribution area (EDA) or horizontal distribution area (HDA).

The shown two-layer FCD network provides redundant and low-latency connections at the cost of requiring a dense fabric 300 with Ns×Ms=Nl×Ml=1024 duplex interconnections (Nlanes=2048 fibers).

Traditionally the mesh fabrics such as the ones shown in FIG. 1 have been implemented over patch panels using hundreds or thousands of patch cords connections to deploy the network topology. More recently, the use of transpose boxes as shown in the prior art can help to deploy those networks while reducing installation errors. Transposed boxes implement a section of the network mesh inside a box using multiple duplex fiber connections or optical flex circuits. The utilization of multi-fiber optical connector components with 4, 8, 12, 16, or more fibers is advantageous since it increases port density. Using transpose boxes, as shown in the prior art, can help to reduce installation errors. However, the prior art cannot easily be adapted to different network topologies, switches radixes, or oversubscription levels.

In this application, we disclosed novel mesh apparatuses and methods to facilitate modular and flexible deployment, of fabrics of different radices, and different sizes, from a few hundred to millions of servers. The disclosed apparatuses and methods also enable a simpler and better-organized interconnection mapping and simpler scaling-out of the network. The methods described here are for both constructing network interconnection modules with complex meshes based on smaller ones (sub-meshes) and also how to use those networks interconnection modules to deploy Spine and Leaf fabrics in data centers.

### PRIOR ART

In U.S. Pat. No. 8,621,111, US 2012/0250679 A1, and US 2014/0025843 A1, a method of providing scalability in a data transmission network using a transpose box was disclosed. This box can connect the first tier and second tier of a network. This box facilitates the deployment of the network. However, a dedicated box for a selected network is required. As described in that application, the network topology dictates the type of transpose box to be used. Changes in the topology can require swapping the transpose boxes. Based on the description, a different box will be needed if the number of Spine or Leaf switches, the oversubscription, or other parameters of the network change.

Once the topology is selected, the application provides a method for scaling. This requires connecting the port of one box to another with a cable. This adds losses to the network and cannot efficiently accommodate the scaling of the network.

This approach disclosed in US 2014/0025843 A1, can work well for a large data center that has already selected the type of network architecture to be implemented and can prepare and maintain stock of different kinds of transpose boxes for its needs. A more flexible or modular approach is needed for a broader deployment of mesh networks in data centers.

In W2019099771A1, an interconnection box is disclosed. This application shows exemplary wiring to connect individual Spine and Leaf switches using a rack-mountable 1RU module. The ports of these modules are connected internally using internal multi-fiber cables that have a specific mesh incorporated. However, the module appears to be tuned to a particular topology, such as providing mesh among four Spine and Leaf switch ports. The application does not describe how the device can be used for topologies with a variable number of Leaf or Spine switches or with a variable number of ports.

In US20150295655A, an optical interconnection assembly that uses a plurality of Leaf-side multiplexers and demultiplexers at each side of the network, one on the Spine side and another set near the Leaf is described. Each mux and demux is configured to work together in the desired topology. However, the application does not demonstrate the flexibility and scalability of this approach.

U.S. Pat. No. 11,269,152 describes a method to circumvent the limitations of optical shuffle boxes, which according to the application, do not easily accommodate for reconfiguration or expansion of switch networks. The application describes apparatuses and methods for patching the network links using multiple distribution frames. At least two chassis are needed to connect switches from one to another layer of a network. Each chassis can accommodate a multiplicity of modules, e.g., cassettes arranged in a vertical configuration. The connection from a first-tier switch to one side of the modules is made using breakout cables, where each of the individual lanes comprising the channel are separated. One side of the breakout cables is terminated in MPO (24 fibers) and the other in LC or other duplex connectors. One side of the modules has one or two MPO ports, and the other six duplex LC connectors or newer very-small form factor (VSFF) connectors.

Similarly, the second-tier switch is connected to modules in the other chassis. The patching needed to connect the switches is performed using a plurality of jumper assemblies configured to connect to the plurality of optical modules. The jumpers are specially designed to fix their relative positions since they must maintain the correct (linear) order. U.S. Pat. No. 11,269,152 describes a method for patching, and it can make networks more scalable depending on the network radix. However, network deployment is still challenging and susceptible to interconnection errors.

### SUMMARY OF THE INVENTION

An optical interconnection assembly has Spine multi-fiber optical connectors and Leaf multi-fiber optical connectors. The Spine optical connectors of the interconnection assembly are optically connected to multi-fiber connectors of Spine switches via Spine patch cords. The Leaf multi-fiber connectors are optically connected to Leaf multi-fiber connectors of Leaf switches via Leaf patch cords. A plurality of fiber optic cables in said interconnection assembly serves to optically connect every Spine multi-fiber connector to every Leaf multi-fiber connector so that every Spine switch is optically connected to every Leaf switch. The optical interconnection assembly facilitates the deployment of network Spine-and-Leaf interconnections and the ability to scale out the network by using simplified methods described in this disclosure.

### BRIEF DESCRIPTION OF THE FIGURES

FIG. 1 shows a two-level FCN with 32 spline fully connected to 32 leaf switches.

FIG. 2 shows a two-level FCN with 32 spline fully connected to 8 leaf switches.

FIG. 3(A) shows a front review of module 400.

FIG. 3(B) shows rear view of module 400.

FIG. 4 shows a top view of module 400.

FIG. 5 shows a top view of module 400 highlighting interconnection arrangements.

FIG. 6 shows mesh 600 interconnections according to Table I, II and III.

FIG. 7 shows mesh 620 interconnections according to Table III.

FIG. 8 shows sub mesh 700 interconnections.

FIG. 9(a) shows a first step of a method to use four identical sub-meshes 700 to produce the full mesh 600.

FIG. 9(B) shows a second step of a method to use four identical sub-meshes 700 to produce the full mesh 600.

FIG. 9(C) shows a third step of a method to use four identical sub-meshes 700 to produce the full mesh 600.

FIG. 9(D) shows a second step of a method to use four identical sub-meshes 700 to produce the full mesh 600.

FIG. 10(A) shows a first step of a method to use four identical sub-meshes 700 to produce the full mesh 620.

FIG. 10(b) shows a second step of a method to use four identical sub-meshes 700 to produce the full mesh 620.

FIG. 10(C) shows a third step of a method to use four identical sub-meshes 700 to produce the full mesh 620.

FIG. 10(D) shows a fourth step of a method to use four identical sub-meshes 700 to produce the full mesh 600.

FIG. 11 shows an illustration of the interconnection scheme of alternative sub-meshes 750 to 772 that can be used instead of 700.

FIG. 12(A) shows the front side of a stack of modules 400.

FIG. 12(B) shows the rear side of a stack of modules 400.

FIG. 13(A) shows the front side of another stack of modules 400.

FIG. 13(B) shows the rear side of another stack of modules 400.

FIG. 14(A) shows a simple method for implementing networks {Ns=64, Nl=32, U=8}, {Ns=32, Nl=32, U=4} from two NlMs 400.

FIG. 14(B) shows a simple method for implementing networks {Ns=64, Nl=32, U=8}, {Ns=64, Nl=32, U=8} from two NlMs 400.

FIG. 15 shows a simple method for implementing small networks {Ns=16, Nl=64, U=2} from four NlMs 400.

FIG. 16 shows a simple method for implementing networks {Ns=16, Nl=64, U=6} from four NlMs 400.

FIG. 17 shows a simple method for implementing networks {Ns=48, Nl=32, U=6} from four NlMs 400.

FIG. 18 shows Table I, a mesh configuration of module 400 using mesh 600 and four uplinks. See Table II for an example of port assignation for the leaf switches.

FIG. 19 shows Table II, an example of NlM 400 port assignation to eight leaf switches with 4 uplinks (using mesh 600).

FIG. 20 shows Table III, a mesh configuration of module 400 using mesh 620 with two or four uplinks. See Table II for an example of port assignation for 32 leaf switches each with four uplinks. See Table IV for an example of port assignation for 16 leaf switches each with two uplinks.

FIG. 21 shows Table IV, an example of port assignation of NlM 400 using mesh 620. Up to 16 leaf switches with 2 uplinks can be connected to up to 16 Spine Switches (see Table III).

FIG. 22 shows Table V, a two-layer FCN with Ns=32 spine or less (depending on the number of ports per spine), and different numbers of leaf switches (NL). The total amount of servers that can be Interconnected was computed using two oversubscription levels. The table also shows the number of NlMs 400, and the occupied space in rack units needed to implement the fabrics.

### DESCRIPTION OF INVENTION

A modular apparatus and method to deploy optical networks of a diversity of tiers and radixes are disclosed in this document. The module and method can be used with standalone, stacked, or chassis network switches as long as the modular connections utilize multi-fiber connectors such as MPOs with 16 fibers. In particular, switches with ports for Ethernet specified as single-mode or multimode fiber optic transceivers, such as 400GBASE-SR8, 800GBASE-SR8, or 800GBASE-DR8, can use these modules without any change in connectivity. Other types of transceivers having 4 optical lanes, such as 400GBASE-FR4/LR4, can also be used by combining four transceiver ports with a hardness or breakout cassette.

Reference is now made in detail to one representative embodiment of the disclosure apparatus and method, examples of which are illustrated in the accompanying drawings. The drawings are not to scale and one skilled in the art will recognize where the drawings have been simplified to illustrate the key aspects of the disclosure.

The claims as set forth below are incorporated into and constitute part of this detailed description. The entire disclosure of any publication or patent document mentioned herein is incorporated by reference. The term “fiber” or “optical fiber” is used herein to mean single-mode optical fiber (SMF) or multimode optical fiber (MMF) unless the context indicates otherwise which form fiber optic cables. The fiber optic cables may have multiple optical fibers, as a non-limited example, fiber optic cable may have one optical fiber to form a simplex fiber optic cable. The term “connector” is used herein to mean a device for terminating one or more optical fibers. The term “adapter” is used herein to mean a device that serves to operably connect two connectors. The term “multi-fiber connector” is abbreviated as “MFC” and refers to an element or elements for connecting multiple fibers and can include, without limitation, any one or combination of connector, adapter, splice, receptacle, port, and the like, such that the fibers may be optically and operably connected. Also, in several parts of this disclosure, the abbreviate S will be used for the Spine switch and L for the Leaf switch.

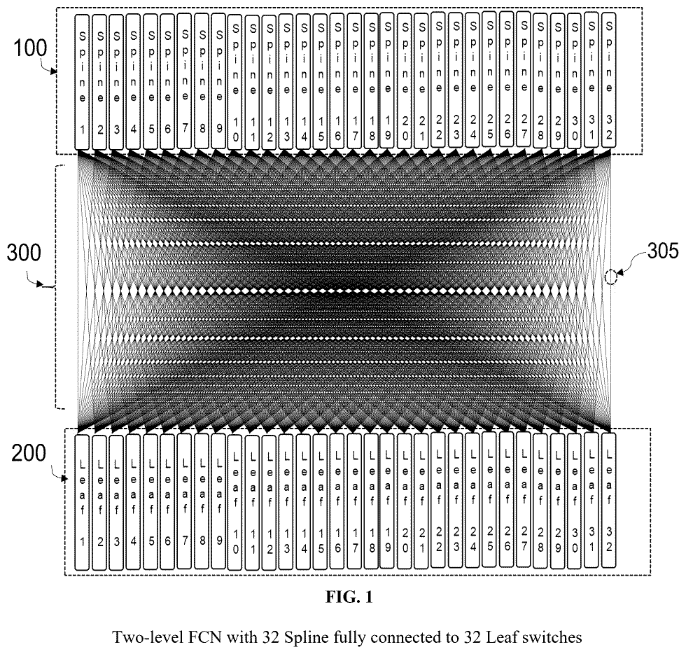

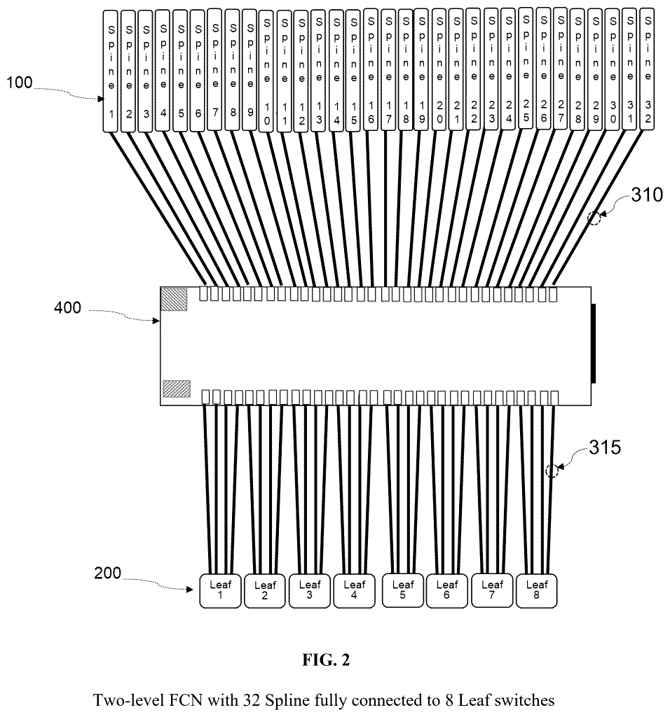

FIG. 2 shows an exemplary optical Network Interconnection Module (NlM) 400, which includes a section of the fabric 300 shown in FIG. 1. However, in FIG. 2 links 310 and 315 represent multi-fiber cables, e.g., a 16-fiber cable. In this figure, the installer connects four uplinks from eight Leaf switches 200 to the NlM 400, using direct connections. From the other side of the NlM 400, the ports can connect 1 of 32 Spine switch multilane ports, where each port consists of 16 fibers (8 duplex channels, i.e., 8 breakout lanes). Alternatively, the Spines can utilize more than one multilane port to connect to the NlM 400 (not shown in FIG. 2). From previous definitions, it is understood that if one NlM 400 can connect to Ms' multilane ports, equivalent to Ms=8×Ms' duplex ports, of Ns Spine, switches, then the number of fibers in each box is given by, 2×Ns×Ms=2×Ns×8×Ms'=512. Since fabric 300 requires 2048 fibers, the NlM 400, with a proper mesh topology that will be described later, already captures 25% of the fabric complexity. In general, NlMs 400 can scale out the network to a wide range of Ns and Nl as described in this disclosure.

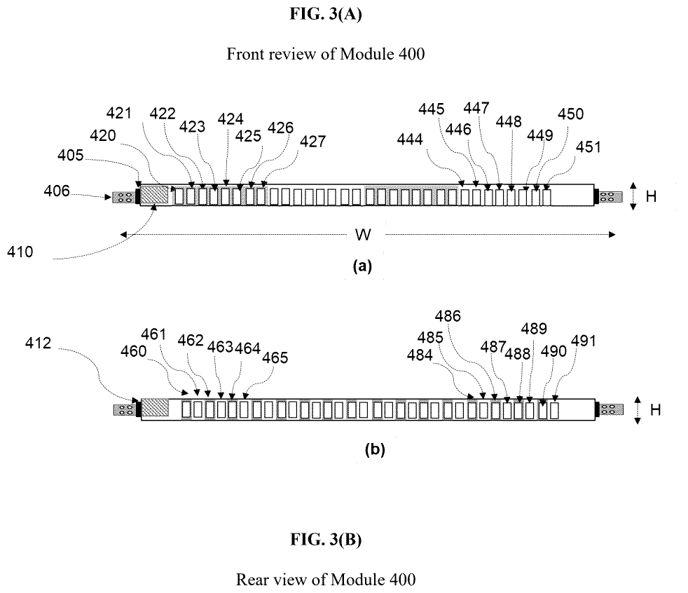

FIGS. 3(A) and (B) elucidate additional details about the NlM 400. FIG. 3(A) illustrates a front view of the disclosed NlM 400, which is the key element in facilitating optical network deployment, reshaping, and scaling. In this embodiment, the module has 64 MPO connectors that can be divided into the front and rear sections, as shown in the FIGS. 3(A) and (B). Alternatively, the 64 ports could be located on one face of the device (not shown here).

For illustration purposes, we assume that ports 420 to 451, each represent an MPO connector located on the front side of the NlM, facing the Leaf switches, as shown in FIG. 3(A). On the other side of the NlM, ports 460 to 491 (opposite to the 420-451 ports), each representing one MPO connector, face the Spine switches, and connections, as shown in FIG. 3(B). The MPO dimensions allow a NlM width, W, which can be in the range of 12 inches up to 19 inches, and the height, H, is in the range of 0.4 to 0.64 inches. The MPO connectors can be placed vertically, as shown in the figure for higher port density. Machine-readable labels 410, and 412, can help deploy or check the network interconnection as described later in this application. Also, lateral rails, 405, on both sides of the NlM, would enable the modules to be inserted into a chassis structure if required. Alternatively, using brackets 406, the modules can be directly attached to the rack. By using the specified height range for this embodiment, up to four NlMs can be stacked in less than 1.3 RU depending on density requirements.

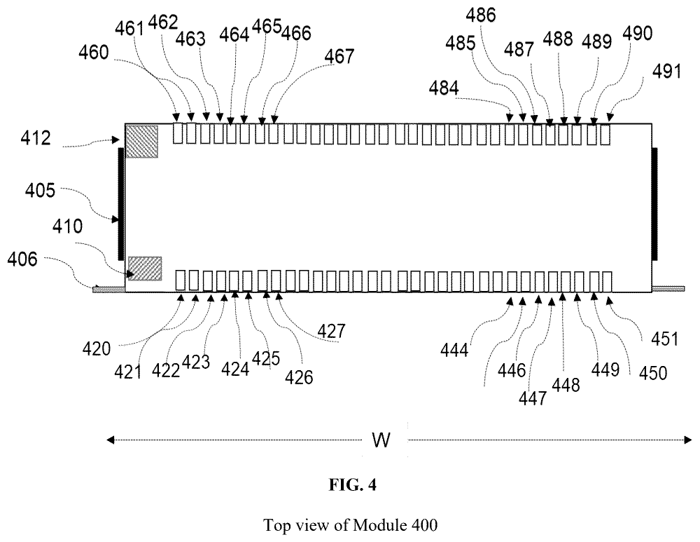

FIG. 4 shows a top view of the NlM, showing additional machine-readable labels 410 and 412. A laser scanner, camera, or RF code reader can read the labels. The unique code can link to a database that has the interconnection maps of all modules in the network. The information can be displayed on a portable device, tablet, phone, or augmented reality lens to facilitate the deployment. See RSs 16563 and 25512 for more specific information on this.

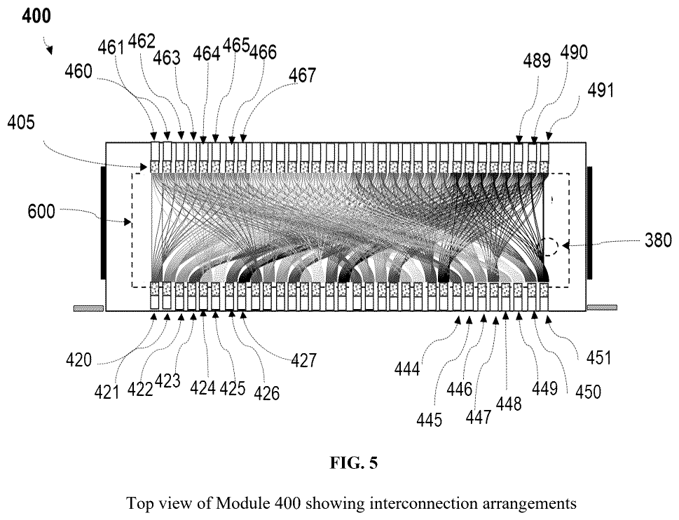

FIG. 5 shows one embodiment of the interconnection scheme of the NlM 400 according to the present invention. The mesh 600 inside the cassette captures the complexity of a section of mesh 300. In that figure, 380 represents one optical fiber or optical waveguide.

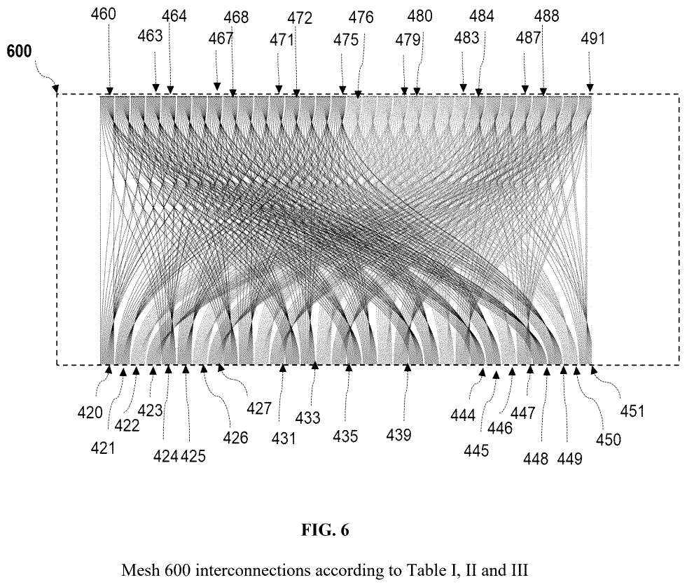

The interconnection map of the mesh 600 in NlM 400 is shown in FIG. 6 and Table I. As described in the table, each output port has meshed with exactly eight input ports. For example, the first eight ports, 460 to 467, which can correspond to Spine, S, switches, S1 to S8, have meshed with ports 420, 424, 428, 432, 436, 440, 444, and 448. The last eight ports, 484 to 491, which can correspond to S25 to S32 have meshed with ports 423, 427, 431, 435, 439, 443, 447, and 451.

An example of port assignation using eight Leaf, L=8, switches with four uplinks, U=4, is shown in Table II.

The mesh 600, inside NlM 400 can be used for fabrics using Leaf switches with four uplinks. By stacking several NlMs 400 we can accommodate for 8 12, or other numbers of uplinks as long as they are multiple of four. Although this covers most of the fabrics, there are cases in which other numbers of uplinks such as 2, 6, 10, 12, or in general might be required. Here we show that it is possible to design some that can be used for a general number of uplinks, 2, 4, 6, 8, 10, or other even numbers, following a simple procedure shown in this document.

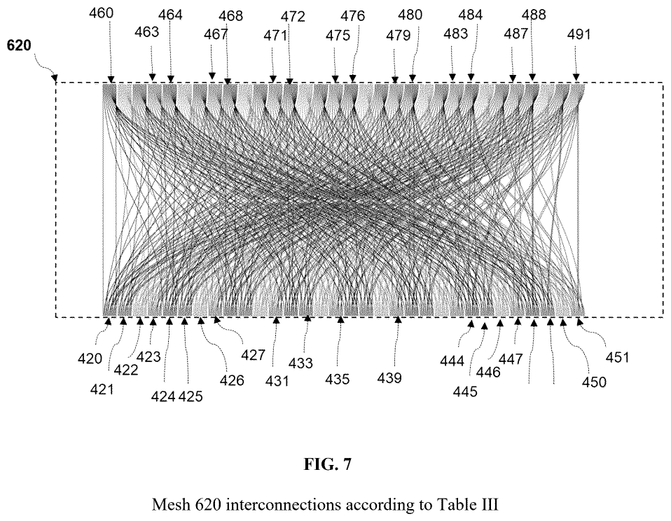

As an example, we show the mesh 620 interconnections in FIG. 7, and the interconnection map in Table III. As described the Table III, each output port has meshed with exactly eight input (front) ports. When Leaf switches with U=4 uplinks are used, the NlM 400 can connect to up to 32 Spine switches, which is similar to mesh 600. For example, the first eight ports, 460 have meshed with ports 420, 424, 428, 432, 436, 440, 444, and 448 which correspond to 8 Leaf switches each with four uplinks as shown in Table II. The last eight ports, 491, have meshed with ports 421, 425, 429, 433, 437, 441, 445, and 449, each with four uplinks as shown in Table II.

The difference between mesh 600 and 620 is that by using 620, we can use the same NlM 400 for a different fabric configurations, e.g., 16 Leaf switches each with U=2. In this case, as shown in Table II the number of Spine switches is reduced to 16 Spines.

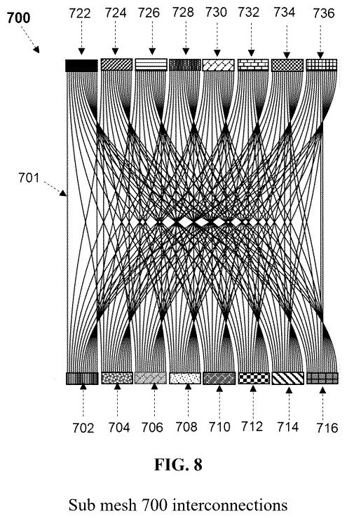

A NlM 400 with mesh 600 or mesh 620 or another one corresponding to a small permutation of ports, can be complex to manufacture, since it requires the interconnection of 512 fibers, in a precise order, to enable the transmitter and receiver ports of the transceivers to communicate. Here, we disclose how to build such complex meshes using 16 ports (8 input/8 output) sub meshes, 700, FIG. 8, where each port uses 16 fibers or optical waveguides to connect to all other ports. In this exemplary sub-mesh 700, the 8 input ports, 702, 704, 706, 708,710, 712,714, and 716, are terminated with multi-fiber optical arrays or connectors, and the 8 output ports, 722, 724 726, 728,730,732,734 and 736, are likewise terminated with multi-fiber optical arrays or connectors. In sub-mesh 700 there are 128 optical fibers, or optical waveguides, 701, that interconnect all input to all output ports.

The sub-mesh 700 is made of optical fibers, embedded in plastic, flexible optical circuit layers, or optical waveguides, such as photonics circuits written in multilayer planes to avoid crosstalk, where each port can be terminated with multi-fiber arrays or multi-fiber connectors such as MPO, or SN-MT. For sake of simplicity in describing the method, here we assume that each port is terminated with MPO connectors, so the labels 702 to 736 represent MPO connectors with 16 fibers.

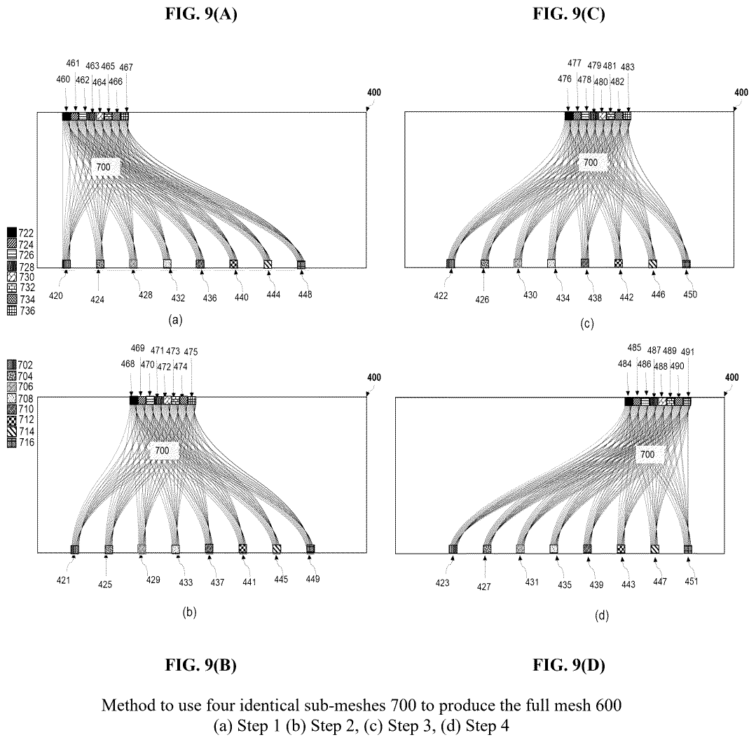

FIGS. 9(A)-(D) show a method to use four sub-meshes 700 of identical interconnection maps to construct a larger mesh such as mesh 600. The method uses temporal or permanent marks or labels in the 16 connectors of sub mesh 700 from 702 to 736, and temporal or permanent marks or labels inside the body of NlM 400, positioned around the external adapters 420 to 451 and 460 to 491.

For example, 32 internal markers or labels associated with Leaf port adapters 420 to 451 and 32 internal markers or labels associated with Leaf port adapters 460 to 491. All the markers or labels are visible during manufacturing for the operator or an automatic vision system. The method could include a map, a list, or a set of instructions for the operator or machine. Alternatively, a diagram such as the ones shown in FIGS. 9(A)-(D), indicates where to connect the MPO connectors of sub mesh 700 to the internal adapters of NlM 400 can be used.

In FIG. 9(A) the input ports of the sub mesh 700, from 702 to 716 are connected to internal adapters of the Leaf ports 420, 424,428, 432, 436,440,444, and 448 of the NlM 400. Also in FIG. 9(A), the output ports of the sub mesh 700, from 722 to 736 are connected to internal adapters of the Spine ports 460 to 467 of the NlM 400.

In FIG. 9(B) a second sub-mesh 700 of identical interconnection map is used. The input ports of the second sub mesh 700 from 702 to 716 are connected to internal adapters of the Leaf ports 421, 425,429, 433, 437,441,445, and 449 of the NlM 400, and the output ports of the sub mesh 700, from 722 to 736 are connected to internal adapters of the Spine ports 468 to 475 of the NlM 400.

In FIG. 9(C) a third sub-mesh 700 of identical interconnection map is used. The input ports of the third sub mesh 700 from 702 to 716 are connected to internal adapters of the Leaf ports 422, 426, 430, 434, 438,442,446, and 450 of the NlM 400, and the output ports of the sub mesh 700, from 722 to 736 are connected to internal adapters the Spine ports 476 to 483 of the NlM 400.

Lastly, in FIG. 9(D) a fourth sub-mesh 700, of identical interconnection map is used. The input ports of the fourth sub mesh 700 from 702 to 716 are connected to internal adapters of the Leaf ports 423, 427, 431, 435, 439,443,447, and 451 of the NlM 400, and the output ports of the sub mesh 700, from 722 to 736 are connected to internal adapters of the Spine ports 484 to 491 of the NlM 400.

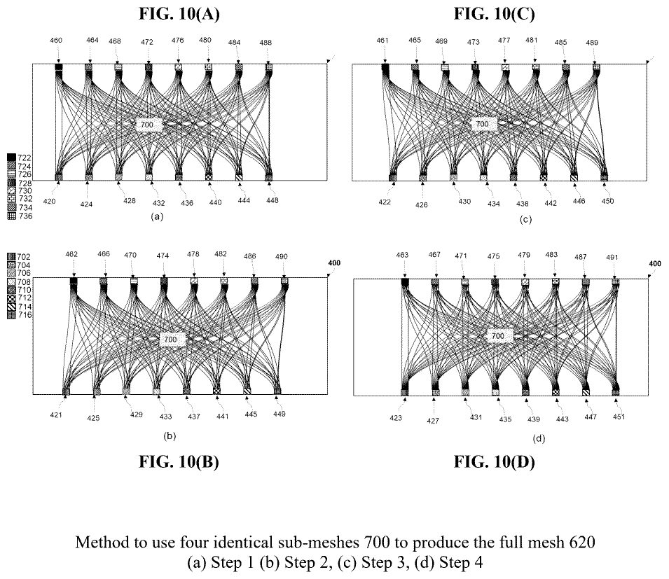

Using a similar method to the one described above, FIGS. 10(A)-(D) show the implementation of mesh 620 from four smaller sub-meshes 700. The method uses temporal or permanent marks or labels in the sub mesh 700 connectors (702 to 736), and temporal or permanent marks or labels inside the body of NlM 400, located nearby the ports assigned to Leaf switches 420 to 451 and the ports assigned to Spine switches 460 to 491.

The method could include a map, a list, or a set of instructions for the operator or machine or a diagram such as the ones shown in FIGS. 10(A)-(D), that indicate how to connect the MPO-16 connectors of sub mesh 700 to the NlM 400 ports.

In FIG. 10(A) the input ports of the sub mesh 700, from 702 to 716 are connected to internal adapters of the Leaf ports 420, 424,428, 432, 436,440,444, and 448 of the NlM 400. Also, in FIG. 10 (a), the output ports of the sub mesh 700, from 722 to 736 are connected to the NlM 400 Spine ports 460, 464, 468, 472, 476, 480, 484, and 488.

In FIG. 10(B) a second sub mesh 700 of identical interconnection map is used. The input ports of the second sub mesh 700 from 702 to 716 are connected to internal adapters of the Leaf ports 421, 425,429, 433, 437,441,445, and 449 of the NlM 400, and the output ports of the sub mesh 700, from 722 to 736 are connected to the NlM 400 Spine ports 462, 466, 470, 474, 478, 482, 486, and 490.

In FIG. 10(C) a third sub mesh 700 of identical interconnection map is used. The input ports of the second sub mesh 700 from 702 to 716 are connected to internal adapters of the Leaf ports 422, 426, 430, 434, 438,442,446, and 450 of the NlM 400, and the output ports of the sub mesh 700, from 722 to 736 are connected to the NlM 400 Spine ports 461, 465, 469, 473, 477, 481, 485, and 489.

Lastly, in FIG. 10(D) a fourth sub mesh 700, of identical interconnection map is used. The input ports of the fourth sub mesh 700 from 702 to 716 are connected to internal adapters of the Leaf ports 423, 427, 431, 435, 439,443,447, and 451 of the NlM 400, and the output ports of the sub mesh 700, from 722 to 736 are connected to the NlM 400 Spine ports 463, 467, 471, 475, 479, 483, 487, and 491.

The described method shows that a very complex mesh 620 with 2048 optical fibers (or optical waveguides) can be constructed with a simpler sub-mesh 700 using four steps.

Controlled permutations of columns and rows in Tables can produce a more meshed with the desired characteristics (operation with 2 or four uplinks). For example, a family of meshes similar properties to Mesh 620 can be produced by,

$${X}_{i , j} = mod ( mod ( α + 2 x ( j - 1 ) - 1 , 4 ) + 1 + mod ( \frac{j - 1}{β} , 2 ) + 4 x λ x ( i - 1 ) , 32 ) + 420 \qquad ( 1 )$$

Where X_{i,j} is a front port of the mesh connected to rear ports

$${Y}_{j} = ( j - 1 ) + 460 \qquad ( 2 )$$

where i, which ranges from 1 to 8 represents a horizontal index in the table, j is a vertical index of the table from 1 to 32, 420 is related to the labels used in this disclosure, and α β and λ, are integers parameters of used to construct the mesh, where α and β can take values from 1 to 8, and λ values from 1 to 4. In particular, mesh 620 shown in Table III was constructed using α=1, β=2, and λ=1. Using other values for parameters α, β and λ, being β and even number≤4, can produce a family of meshes capable of operating with a different number of uplinks, e.g., 2, 4, 6, 8, 12, or another number of uplinks, using the same NlM 400 (no need to mix NlMs of different configurations).

In addition to those permutations between the ports of NlM 400, 420 to 451, and sub-meshed ports 702 to 736, to produce meshes 620, or others with the desired properties described above, the ports of the sub-mesh 700 can be permuted in a controlled way.

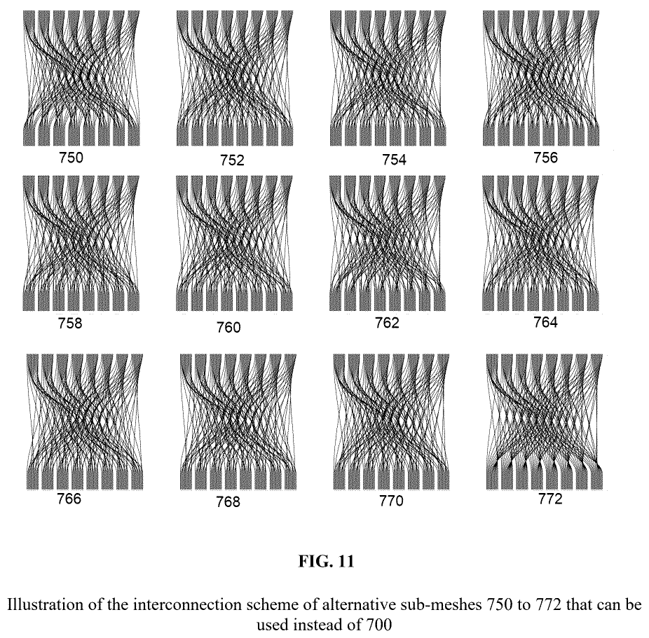

FIG. 11 shows examples for 12 alternative sub-meshes 750 to 772. All those meshes connect all input with all output ports and maintain order to enable communication from the laser transmitter to photodetectors of communicating transceivers.

Independently of the utilized sub-mesh in the construction method described above (FIGS. 9(A-(D) and 10(A)-(D), it is required for the four sub-meshes to be identical.

Hence, according to the present invention, an apparatus mixes the Ethernet physical media dependent (PMD) lanes with other transceiver PMD lanes to facilitate interconnections of Spine and Leaf switches and distribute the traffic flow among multiple redundant paths. The mesh incorporated in each module 400, using the described fabrication method, increases the degree of fiber connections inside each module.

The apparatus 400 simplifies the network deployment since a significant part of the network complexity is moved from the structured cabling fabric to one or more modules 400. Using module 400 and following simple rules to connect a group of uplinks or downlinks horizontally or vertically, the installation becomes cleaner, and cable management is highly improved, as shown in the following description of this application.

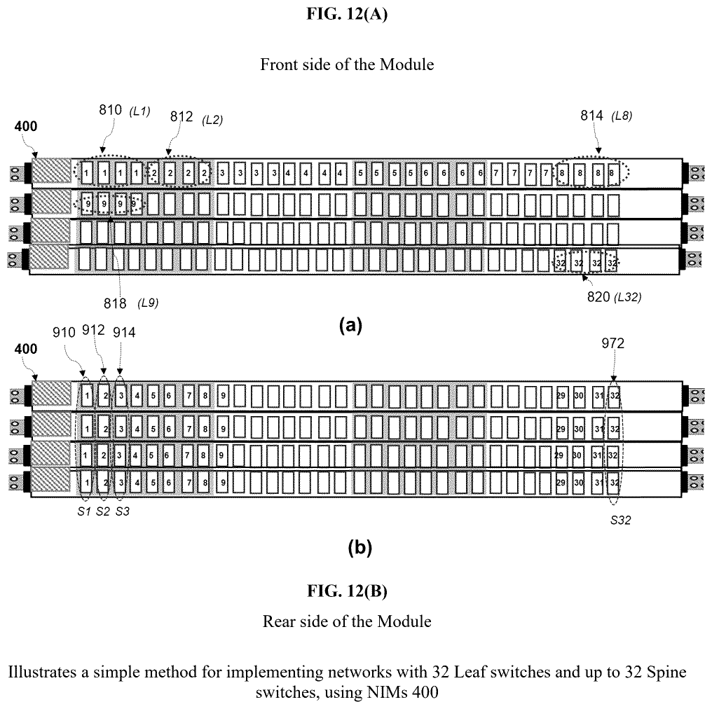

A stack of several modules 400 can enable networks of diverse configurations and radixes, with various numbers of Spine and Leaf switches. For example, FIGS. 12(A) and (B) show a stack of four modules 400 required to connect thirty-two Leaf switches, each with four MPO-16 uplinks, (U=4), to thirty-two Spine switches, each with four MPO-16 downlinks. This stack configuration enables the deployment of the fabric 300 shown in FIG. 1. FIG. 12(A) shows the module side that is connected to the Leaf switches. For simplicity, we label this as the front side. FIG. 12(B) shows the opposite side of the same module 400, the backside, which is connected to the Spine switches.

In this illustrative example, {Ns=32, Nl-32, U=4), the uplinks of the Leaf switches are connected horizontally in groups of four. For example, 810 ports connect to the fourth uplinks of the first Leaf switch, and 812 connect to the fourth uplinks of the second Leaf switch. The last four ports of the first module 400 in the stack, 814, connect to the fourth uplinks of the eighth Leaf switch. Following the previous description, we can say that module ports 810, 812, and 814 connect to four uplinks from Leaf switches L1, L2, and L8. The first ports of the second module 400, ports 818, connect to the uplinks of the ninth Leaf switch (L9). And the last ports of the bottom module 400 in the stack, ports 820, connect to four uplinks from the thirty-second Leaf switch (L32).

The Spines ports are assigned at the backside of the stacked modules 400, as shown in FIG. 12(B). Depending on the number of ports of each Spine different configurations can be followed. For example, 910, 912, 914, and 916 could correspond to ports of the first, second, third, and thirty-second Spine switch, respectively, labeled as S1, S2, S3, and S32 in FIG. 12(B). Using this configuration, a fabric with 16 Spines and 32 Leaf switches, similar to the fabric 300 can be deployed.

The disclosed network interconnect module 400 can also be used to build and scale-out networks having 8 or 4 Spine switches following the same basic rules as described above. For 8 or 4 Spine switches, rule states “Spine switch MFC uplinks are populated vertically in columns of NlMs 400 and must maintain the same relative vertical column position.” For 8 spines, the 16 MFC Spine uplinks roll over to occupy 2 consecutive columns instead of 1. For example, in FIG. 12(B), S1 and S2 ports can connect to the first Spine, S3 and S4 to the second Spine, and S31 and S32 ports to the sixteenth Spine, this produces a fabric with 16 Spines and 32 Leaf switches.

Alternatively, S1, S2, S3, and S4 ports can connect to the first Spine, S5, S6, S7, and S8 to the second Spine, and S29, S30, S31, and S32 to the last Spine, this produces a fabric with 8 Spines and 32 Leaf switches.

In another configuration, the ports S1 to S8 can connect to the first Spine, S9 to S16 ports can connect to the second Spine, and S25 to S32 to the last Spine. This produces a fabric with 4 Spines and 32 Leaf switches.

Otherwise, by using two Spines, e.g., two chassis Spine switches, each S1 to S16 will be connected to the first Spine and the rest to the second Spine, producing a fabric with 2 Spines and 32 Leaf switches.

The maximum number of connected network servers depends on the number of Leaf switches, server ports, and the oversubscription used as shown in Table V. For example, consider a fabric with Ns=32 Spine switches and Nl≥Ns Leaf switches with 128 duplex ports, grouped for example as 96 LC duplex downlinks and U=4 MPO-16 uplinks. Each Leaf switch can connect to 96 Server ports, and the four MPO-16 are routed to Spine switches via NlMs 400. The first row of Table V shows that to implement the fabric {Ns=32, Nl=32, U=4}, four NlMs are needed as shown in FIGS. 12(A) and (B). Those four NlMs 400 occupy a rack size of about 2 RUs as shown in Column 5 of the same table. The number of fibers inside the NlMs, which represents the complexity removed from the fabric to the NlMs, is 2048 as shown in the last column.

The number of servers for the same fabric, {Ns=32, Nl=32, U=4} with over-subscription, O=3:1 is 3072 as shown in column 4. As the table shows, the fabric can scale just by adding a stack of NlMs 400, in one or more racks. Using chassis Spine switches, e.g., a chassis with 16 line cards, each with 32 ports, the last row of Table 2 shows that a fabric that interconnects uses Nl=4096 Leaf switches, and ˜3.9 million servers can be implemented systematically.

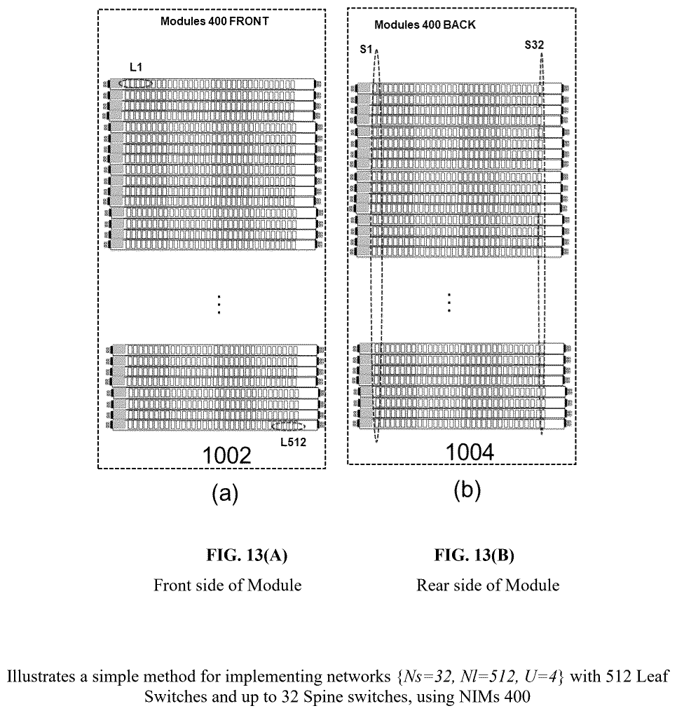

The network deployment using stacks of NlMs 400 allows for several configuration alternatives. As shown previously we can reduce the Spines from 32 to 2 by grouping columns on the back of the NlM 400 modules. FIGS. 13(A) and (B) show another example extracted from that table for {Ns=32, Nl=512, U=4} which requires 64 NlMs 400. In these figures, the connection scheme of the stack is shown from both sides of modules 400, one labeled front, 1002, and the one labeled back, 1004. The 1002 side connects to 512 Leaf switches, each having four MPO-16 uplinks. For example, the fourth L1 uplinks are connected adjacently in the first four ports of the first module 400. All L512 uplinks are connected to the last four ports of the 64th module 400. From the back side 1004 of the same module stack, 32 Spine switches connect vertically, (columns S1-S32 representing Spines) as shown in the FIG. 13(B).

Previous examples, use Leaf switches with four MPO-16 uplinks (U=4). However, NlM 400 can work with a diverse number of uplinks. For example, for Leaf switches that have U=8, 12, 16, or 4×K MPO-16 uplinks, where K is a positive integer. For those fabrics, the deployment method described above is still useful, with the only difference being that the process is repeated K times. For U=8, (K=2), this is equivalent to duplicating the stack or in other words, using two {Ns, Nl, U=4} stacks as equivalent to one {Ns, Nl, U=8}.

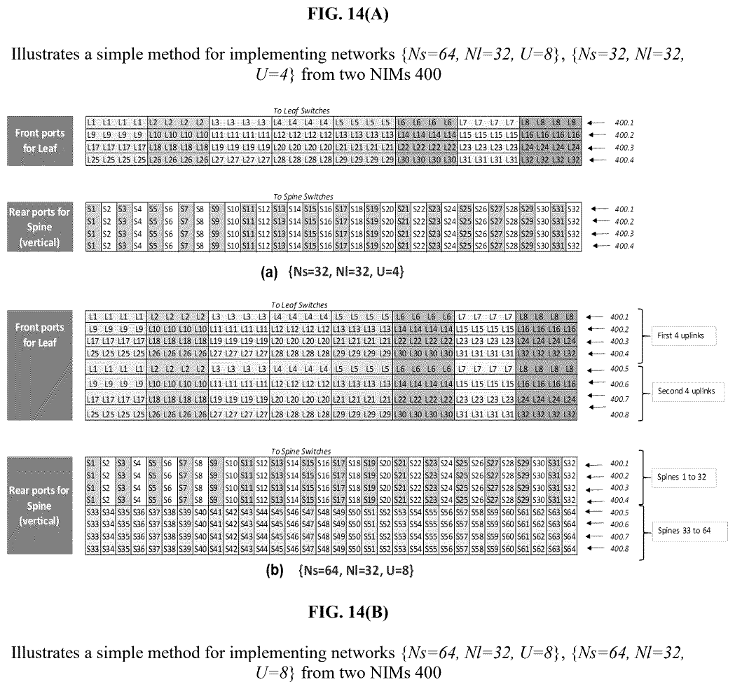

We illustrate this case in FIG. 14(B), where the fabric {Ns=64, Nl=32, U=8} is implemented. FIG. 14(A) shows a simplified schematic of the fabric {Ns=32, Nl=32, U=4}, a stack of four NlMs 400, 400.1, 400.2, 400.3, and 400.4, identical to the mesh configuration in FIG. 12(A). As shown previously, the uplinks of the Leaf switches, L1 to L32 ports are connected horizontally, and the Spine switches are connected vertically to ports S1 to S32.

In FIG. 14(B), we duplicate the stack of NlMs 400, to provide ports to the additional 4 uplinks of the Leaf switches. Depending on how we group the number of ports of each Spine, different configurations can be followed. For example, each vertical column can be grouped to enable 32 Spine switches. or they can be separated as shown in the figure, to utilize 64 Spine switches S1 to S32 in the first stack and S33 to S44 in the second stack.

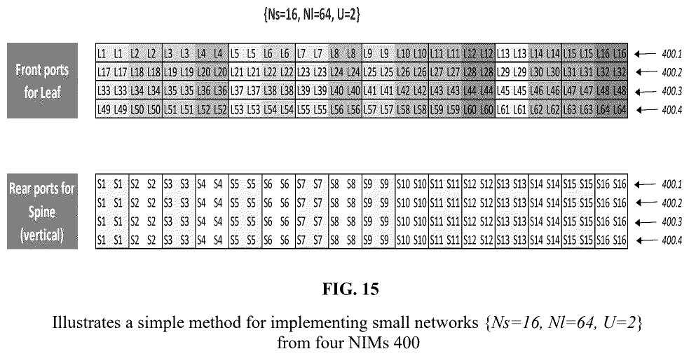

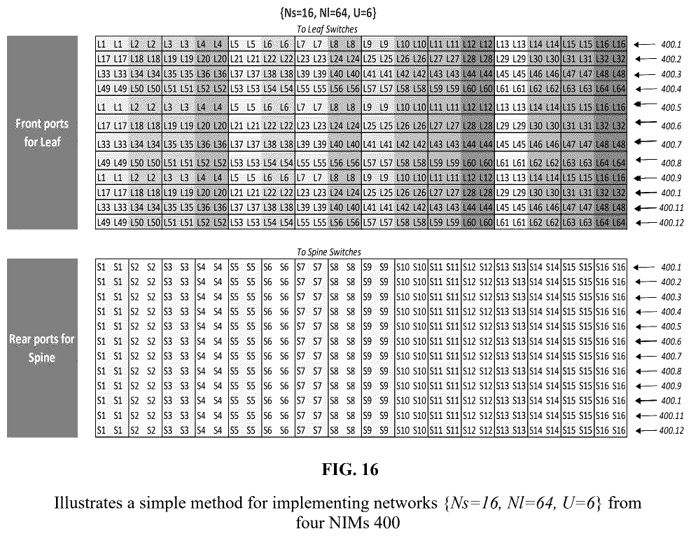

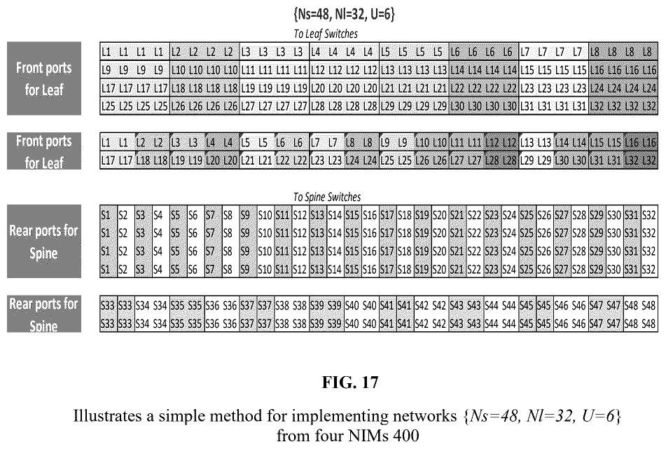

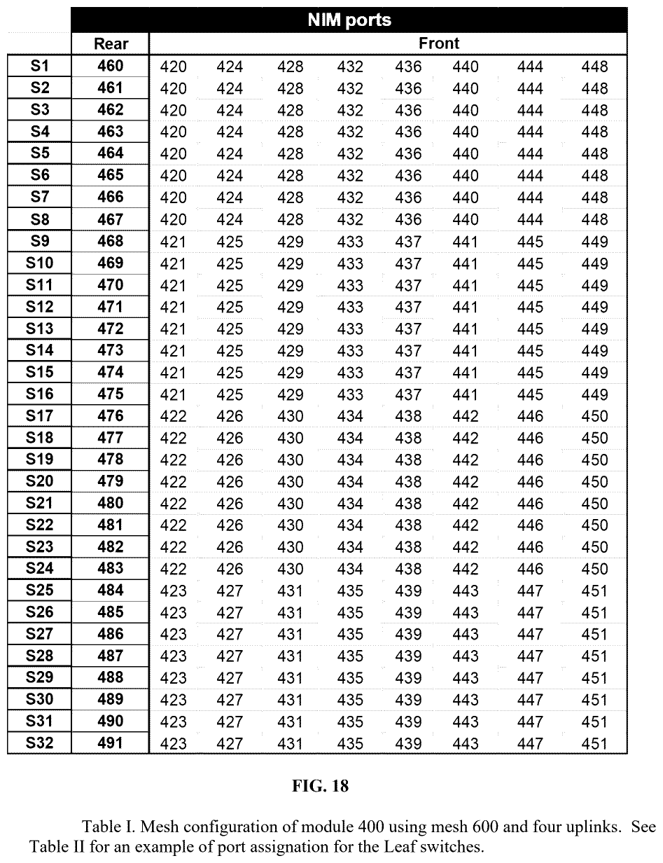

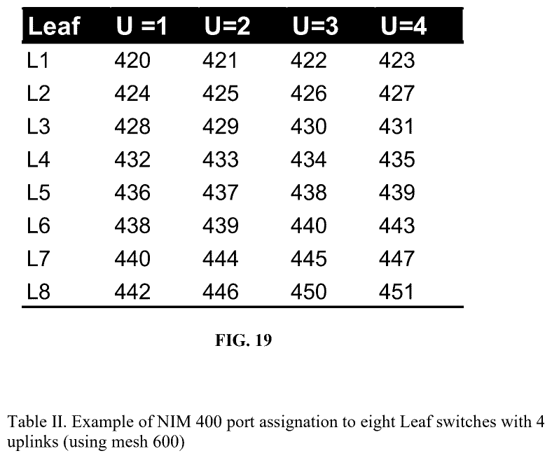

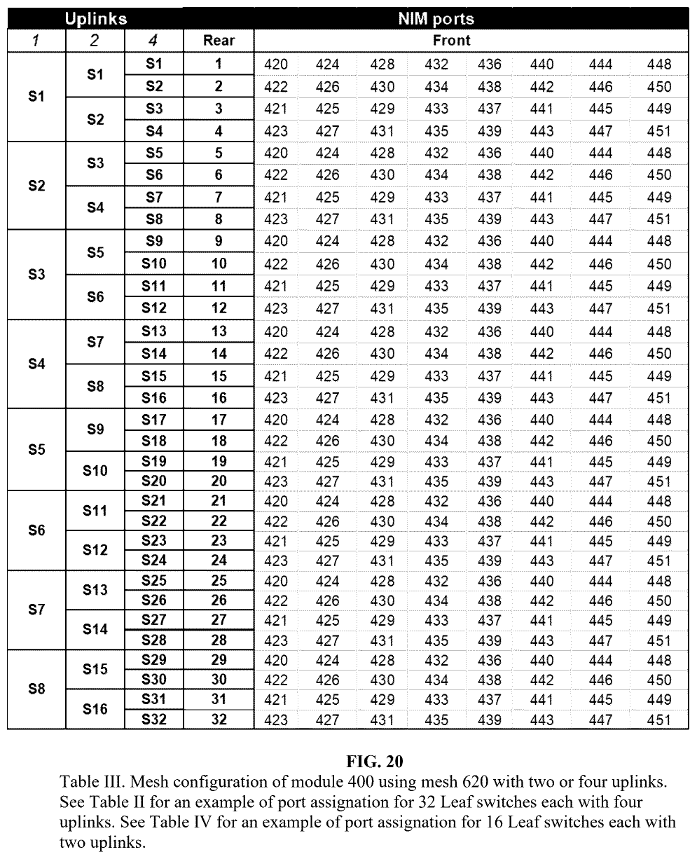

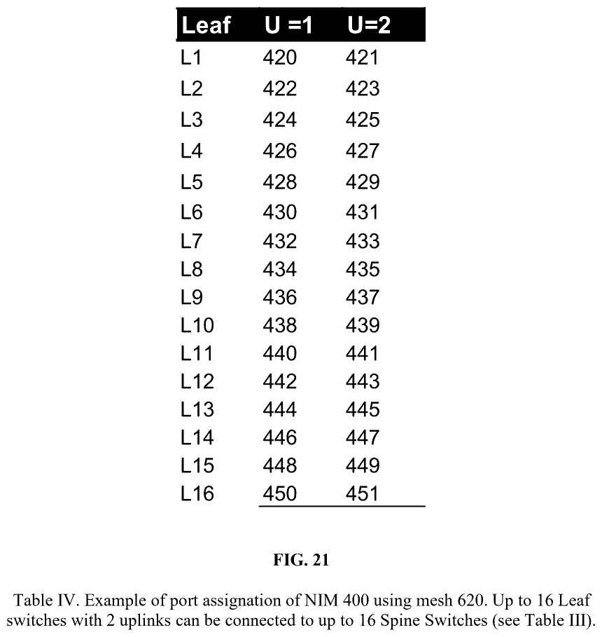

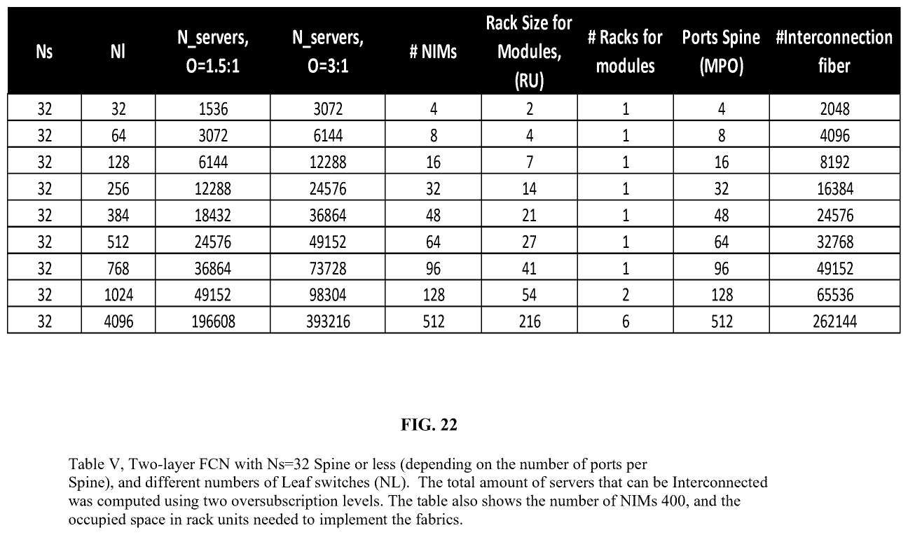

The NlMs 400 using Mesh 620, or a similar following equation (1-2) with the mentioned a, B, and λ, parameters, can be used when the number of uplinks is not a multiple of 4. FIG. 15 shows an example, for {Ns=16, Nl-64, U=2} using only two MPO-16 uplinks, a stack of four NlM 400. Examples using six MPO-16 uplinks are shown in FIGS. 16 and 17. In FIG. 16, we use six uplinks to produce fabric, of 16 Spine and 64 Leaf switches. Following the interconnection scheme, where Leaf connects horizontally to the ports in consecutive groups of two, this method can be scale-out to thousands of switches, by increasing the number of NlMs 400 in the stack.

FIG. 17 shows six uplinks are used to increase the number of Spine switches to 48.

In summary, using the NlMs 400 and following the connections methods described above, a diverse type of fabrics with 2, 4, 6, 8, 10, 12, 16, or more uplinks, of small or large sizes can be implemented. Moreover, the NlMs enable fast fabric scaling or reconfiguration when needed.

The aggregated data rates per NlM 400e can be estimated using, Dₐ=f×Nₛ×Mₛ×D, where N_{f} is the number of fibers used per connector, N_{c}, is the number of connectors NlM 400, e.g., Ms′=32 multi-fiber ports, e.g., MPO-16, Mₛ=16×Ms′=512, D is the data rate per fiber in one direction. Factor f is 1 for duplex networks and two for bidirectional networks. For example, assuming that Nₛ=32, and D=200 Gbps, Da=6.5 Pbps per a stack of 64 NlMs 400 and approximately 300 Tbps per RU.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. Clos, Charles (March 1953). “A study of non-blocking switching networks”. Bell System Technical Journal. 32 (2): 406-424. doi: 10.1002/j.1538-7305.1953.tb01433.x. ISSN 0005-8580.
2. W. J. Dally and B. Towles, Principles and practices of interconnection networks, The Morgan Kaufmann Series in Computer Architecture and Design, Hardcover ISBN: 9780122007514

What is claimed is:

1. An apparatus having a plurality of multi-fiber connector adapters, where said adapters connect to network equipment in a data communications network, and where the apparatus incorporates an internal mesh having 512 optical fibers, implemented by concatenating or interleaving four identical sub-meshes, each comprising 128 optical fiber interconnections.

2. The apparatus of claim 1, wherein the apparatus is configured to be stacked to provide folded Clos network topology of various radixes.

3. The apparatus of claim 2, wherein the apparatus is configured to be used to scale optical networks from four to thousands of switches.

4. The apparatus of claim 1, wherein the apparatus is configured to have a small form factor that allows to stack three modules in one RU.

5. A structured cable system comprising a stack of modules, where each module has a plurality of optical parallel connector adapters, incorporate an internal mesh of 512 ports, implemented by concatenating or interleaving four identical sub meshes, each with 128 ports, wherein a stack of modules can be used to deploy or scale various Clos network topologies.

6. A fiber optic module apparatus which comprises, a main body, a front face, a rear side, a left side, a right side, and an internal structure wherein:
a. the front face accommodates a multiplicity of multi-fiber connectors;
b. the rear face accommodates a multiplicity of multi-fiber connectors, identical in number to the front face;
c. the internal structure of the module provides space for optical lanes having optical fibers or optical waveguides;
d. where the optical fibers or waveguides connect fibers of the front face multi-port fiber connectors to fibers of the rear face multi-port fiber connectors;
e. where the connections follow an interconnection map that produce a mesh configuration; and
f. where the pattern of the mesh can be constructed using four identical, but simpler sub meshes.
